(19) United States
(12) Patent Application Publication
(10) Pub. No.: US 2009/0070575 A1
(43) Pub. Date: Mar. 12, 2009

(54) MEMORY WITH DATA SYNCHRONIZATION FROM AND FOR A DRIVE CONTROLLER OF A MACHINE

(75) Inventor: Martin Ehlich, Kalletal (DE)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: LENZE DRIVE SYSTEMS GMBH, Aerzen (DE)

(21) Appl. No.: 11/995,096

(22) PCT Filed: Jul. 10, 2006
(86) PCT No.: PCT/EP2006/064069

§ 371 Date: Nov. 6, 2008

(30) Foreign Application Priority Data
Jul. 8, 2005 (DE) 10 2005 032 075.9

(51) Int. Cl. G06F 15/177

(52) U.S. Cl. 713/2

(57) ABSTRACT

The aim of the invention is to improve the start-up of an electrical machine drive control system comprised of at least one machine (80) and of at least one machine control (100; 90, 95). The start-up should proceed in such a manner that, during servicing, a quicker and more reliable device exchange is made possible. Methods are provided for starting up as the first or new start-up. A boot memory area (50) for storing machine-related data is provided that comprise at least a number of first parameters for a number of controllers (12) and a number of user-specific second parameters of the drive control system. The first and second parameters are permanently stored in the boot memory area. The storage area (50) is organized on a module, which can be removed from and inserted once again into the machine control (100; 90, 95). A transmission of all machine-related data ensues from the b boot memory area (50) of the module to the machine control (95).

### CROSS REFERENCE TO RELATED APPLICATIONS

This application is a U.S. National Stage Application of International Application No. PCT/EP2006/064069, filed Jun. 10, 2006, which claims the benefit of German Patent Application No. DE 10 2005032075.9, filed on Jul. 8, 2005, the disclosure of which is herein incorporated by reference in its entirety. PCT/EP2006/064069 designated the United States and was not published in English.

### FIELD OF THE DISCLOSURE

Embodiments of the invention relate to a number of methods for use in motor-driven drive control systems, which include at least one machine as the drive and a machine control, wherein the latter control comprises a power element and a control element.

### BACKGROUND OF THE DISCLOSURE

Conventionally, there have been difficulties associated with performing a start-up in a cost-efficient manner.

Conventionally, start-up operations for established arrangements consisting of machines and machine controls require a console. For the most part, this is a PC or a display unit comprising an operator console, which is used by a trained and experienced user, so as to set the machine control to the machine and to the user environment, which is affected here via an interface. To an increasing extent, the settings are automated; that is, they are, for the most part, self-setting or self-identifying. However, the start-up by a trained user or by an engineer, who is experienced in drive engineering, who has informed himself about the possibilities and the needs of the user environment, which is to be set, conventionally forms the basis for such an identification.

### OBJECTS OF THE DISCLOSURE

An object of the invention is to simplify the stan-up. In particular, the start-up is to be able to take place in such a manner that a quick and reliable device exchange becomes possible in case of service and that qualified operating staff is not necessary for subsequently carrying out a start-up in the same user environment. The series stan-up can be carried out in such a manner that special knowledge is not necessary, that the trained engineer is not required to come on site for the start-up and that additional operating elements or operating devices need not be ported and connected for performing presettings of the machine drive environment via the interface.

### SUMMARY OF THE INVENTION

Disclosed exemplary embodiments include methods to enable and improve a series start-up, wherein the term start-up is to be understood to be a general term. Such a start-up is not only a first-time start-up of said machine drive control system, but also a new or repeated start-up, either after maintenance or an exchange of defective components of the machine control.

Exemplary embodiments explain and supplement the claimed invention.

### BRIEF DESCRIPTION OF THE DRAWINGS

FIG. 1 illustrates an exemplary embodiment in a schematic view of a machine control 100 for a machine, which is represented in two applications as a direct current machine 80 and as a three-phase machine 81, respectively.

FIG. 1a illustrates a sectional enlargement from FIG. 1 in an angular side view, including a removable memory module 50, which is electrically connected with the main circuit board 1 of the machine control 100 via a connection plug board or a socket board 15 (strip). Both the electrical connection and the mechanical connection are removable and may be removed when the module 50 is detached from the strip 15.

FIG. 2 illustrates a second exemplary embodiment in a schematic view of a machine control 100 including a remote memory 51 at a host 60.

FIG. 2a illustrates a third, more schematic exemplary embodiment of a machine control 100 including a remote memory 51′ in a host 60′.

### DETAILED DESCRIPTION OF THE DISCLOSURE

The following description is intended to convey a thorough understanding on the embodiments described by providing a number of specific embodiments and details involving memory with data synchronization from and for a drive controller of a machine. It should be appreciated, however, that the present invention is not limited to these specific embodiments and details, which are exemplary only. It is if further understood that one possessing ordinary skill in the art, in light of known systems and methods, would appreciate the use of the invention for its intended purpose and benefits in any number of alternative embodiments, depending on specific design and other needs.

In exemplary embodiments, the method operates with a boot memory area and with a transmission of machine-related data from this boot memory area into the user environment, which is the machine control. There, provision is made for a mirror boot memory area, which corresponds to at least one section of the normal main memory, which is used by the machine control for controlling the operation of the machines.

In some embodiments, the “machine-related data” may include at least first parameters and a number of user-specific second parameters, which relate to the drive control system. The first parameters may setting values, which create settings. The second parameters may be user-specific parameters, which can also include user programs (or parts thereof).

In some embodiments, the user programs may specific and adapted, respectively, to the respective specific application. The adaptation makes it possible that the data taken over from the boot memory area into the mirror boot memory area represent the start-up, wherein the sole transmission (and storage) of this data in the mirror boot memory area substantially concludes the start-up process.

In some embodiments, further adaptations may then be performed by the machine control itself via identifications or self-settings and the appropriately changed first parameters thereby overwrite the values in the same memory cells in the mirror boot memory area.

An instantiation of the “machine-related data” is to be performed in such manner that they are sufficient and equally necessary for the operation of the machine. These are thus all of the necessary data, which must be available for the operation. At the same time, these are adequate or sufficient data and user programs, which enable a start of the regular operation of the drive environment. These are not only a few data or only a few parameters, but truly relevant parameters as machine-related data, without which a start-up and an operation of the user environment would not be possible.

In some embodiments, the boot memory (area) itself can be removed, that is, it can be disconnected and inserted again, relating to the machine control. In an alternative variant, this boot memory area may be a remote memory (area), which may be arranged away from the machine control, it can also not be removed from said machine control. Instead, it is located at a distance therefrom, preferably at a very far distance, so that it can only be reached via a data network connection.

However, a physical distance is not an obstacle for a logical proximity, in that the machine-related data is written into the mirror boot memory area on the machine control via the data network connection in response to a start-up, for the purpose of which the data is initially transmitted via the data network connection.

In some embodiments, the transmission of the data network connection may be bidirectional, relating to all of the machine-related data, wherein this data can also be updated after a start-up and during the regular operation, that is, not only updated in the mirror boot memory area of the main memory, but the data can be updated by the machine control via the data network connections or via the plug contact.

The operation therefore ensures that the experiences acquired in the operating environment are also learned back in the form of changed parameters or in the form of converted regular types. Said backlearning process is a data synchronization, with which the appropriate memory cells are overwritten and updated in the boot memory area.

The invention thus creates the premise for the fact that a subsequent exchange of the user environment (i.e., the machine, the machine control, or components of this machine control) does not have to result in a new start-up that involves re-learning or re-inputting first and second input parameters—which have been learned, which are very specific for the application, and which fit precisely. Instead, first and second parameters can be transmitted from the boot memory area back into the mirror boot memory area directly for or in response to a new start-up. They can be stored there and, in spite of its second and further start-up, if applicable, the machine arrangement may be prepared as if an exchange of components had never taken place.

A series start-up is thus made much easier: qualified operating may be rarely required, if at all; special knowledge is hardly required for the start-up; and a new start-up and the exchange can still take place safely and reliably. The “service case” is no longer a reason for a longer outage break, but can be converted into a new start-up by the person, who is responsible on-site or by the user himself.

In some embodiments, the memory module is not a fixed, inseparable component of the drive controller, but can either be arranged remotely therefrom or can be detached and removed therefrom by means of unplugging.

In some embodiments, the latter portable memory may be secured against a power failure; that is, it is designed for a permanent storage, which is self-evident for the remote memory area, which is not turned off with the drive, but which operates independently therefrom.

In some embodiments, the memory area may include all of the user-specific parameters and programs, which are required for the drive environment. In response to the first-time start-up (and in response to each following start-up) a transmission of the first and second parameters ensues one time, as described, from the boot memory area into the mirror boot memory area. The presence of invalid parameters and invalid programs in the mirror boot memory area is an indication for the machine regarding the first time occurrence of the transmission. Once such a transmission has been carried out, the further control of the machine control ensues only from the mirror boot memory area. It is to be avoided that a control ensues with first or second parameters, in particular with user programs, out of the boot memory area. Prior to a regular operation, the latter must and will be first transmitted into the mirror boot memory area, is stored there and all of the data information concerning this matter, which is included there, is deleted thereby.

In a corresponding reverse application, a retransmission may thus take place bit by bit. This retransmission allows for the boot memory area to become more specific and more adapted with reference to the user environment, which is networked or assigned therewith.

In some embodiments, this data synchronization can be designed in such a manner that user programs as such are not overwritten. At least one structure of at least one controller, which was provided by the user programs and which was defined as being capable of being changed, may be changed by the storage. On the other hand, provision can be made for the deliberate overwriting process of at least parts of user programs. An overwriting process and a new definition of a program segment, for example as a control program or as a monitoring program ensue as part of the second user-specific parameters. This can be preceded by a change or update in the main memory of the machine control, for example by means of a PC tool, which may act directly on the main memory of the drive controller. A program control, which has been carried out in such a manner, may be transmitted to the module comprising the boot memory in response to a data synchronization and may overwrite the appropriate user program or at least a part of a larger user program there. In response to the start-up or, in the alternative, in response to a new start-up, the opposite way can also be chosen. User programs may at least be partially transmitted from the boot memory area and overwrite the corresponding user programs (or at least parts thereof, which were stored in the mirror boot memory area of the main memory of the machine control.

Assuming a data transmission, a modification storage may also accompany this data transmission of the machine-related data. This change may be final and definitive, without retaining the backup copy made previously at the location of the modification storage (that is, either at the remote host backup storage or at the mirror boot storage, which is arranged on the machine control).

In other words, it can be said that the machine control initially operates as slave, driven by the master, which is the boot memory area. After a transmission from the master memory area into the slave memory area, the machine control assumes the characteristic as master and treats the boot memory area as a backup storage in terms of a slave. Updated machine-related data are written to the boot memory area as first and second parameters and they delete (overwrite) the appropriate parameters, which were provided by the boot memory area in response to the first start-up.

This allocation, however, is not irreversible, but may lead to a new inversion when the machine control must be put into operation once again, that is, when an exchange of components has taken place or another service case has arisen. The boot memory area then receives the master function once again up to the transmission of the first and second parameters, which it had kept for this user environment. All of this machine-related data may be transmitted and stored, regardless of possible remainders or remnants in the mirror boot memory area so that the generally understood start-up is ensured.

Due to the system of allocating the respective subordinate master function, it can also be ensured in the long run that none of the first and second parameters are lost for the user environment. Instead, they may be returned gradually into the boot memory area during the operation and overwritten there; they may be taken over once again from there either as a package or a bundle in response to a start-up.

A triggering of such a transmission can ensue in many ways. One of them has already been discussed, by means of identifying valid parameters or valid programs in the mirror boot memory area. Another way is the turn-on process of the drive system, in response to which a transmission from the boot memory area may be triggered. The triggering stands for an activation of a routine, which initially carries out the transmission so as to then transfer the control to the machine control, which subsequently operates with the transmitted data from the main memory.

A further possible triggering of a transmission process is a turn-off process. To ensure that a turn-off process transmits all of the first and second parameters, which are currently valid, from the main memory into the boot memory, a second routine can be started, which initially carries out the complete transmission so as to then freely control the turn-off process of the drive arrangement.

The data provided in the boot memory area must not yet be complete specific data, but can include a certain generalization, which are so-called default settings. That is, they are not completely geared to the application, but they can also be not geared and specific to the application at all. The adaptation of this raw information first takes place during the operation of the drive system. From there, the information is then also transmitted back into the boot memory area by means of a data synchronization so as to better tailor this memory area to the available user environment for a future start-up.

In some embodiments, a type of the multiplication in terms of a cloning of the memory information in the boot memory area may come about if said boot memory area is divided once or several times.

The staging or the data synchronization in the aforementioned terms of a backlearning may then take place in parallel on at least two divided boot memories so that one of them can be removed and can be used as main boot memory in another drive. The multiplication of this acquired drive information, which has been acquired in such a manner, from a start-up and an operating period of a first drive to a second drive environment may enable the multiplication and facilitation of a series start-up.

Instead of to this series start-up, however, it can also be directed to increasing the reliability and redundancy so that one of the boot memory areas remains in the machine control for the respective update and so that a second boot memory area may be removed as backup and may be stored at a secure location in the electrical cabinet.

These memories, which form the boot memory area, may be write-read memories comprising an access time, which is identified as at least a rapid access time. These are not CD-ROMs or other rewritable data carriers, which would be identified as being sluggish and slow. For the most part, the memories are designed as electrical memory cells, for example as portable “memory stick” in the form of a portable memory comprising USB interfaces, for example, for the machine control.

It is not necessary to provide a large memory in terms of memory capacities of above 10 MB, which are provided by today's portable memory sticks. However, it would not be amiss for the manageability or robustness of such a memory device to comprise more memory than is required for the actual memory volume of the boot memory area. Considerably smaller amounts of data, which are required and adequate for the drive environment, are already sufficient here to enable them to carry out an independent operation by the start-up from the boot memory area.

The method may be embodied further with the removable boot memory area in that an automatic triggering ensues if a boot memory area is inserted into the appropriate plug receptacle during the operation; that is, during a proper operation of the motor-driven drive control system. The motor control will interpret this in such a manner that the available first and second parameters are interrogated by the inserted boot memory area and stores all of the available machine-related data from the main memory back into the boot memory. The data, which are available there, are either overwritten completely or are overwritten only insofar as deviations had been determined by means of a comparison. The comparison updates only those data in the boot memory area, which do not correspond to those machine-related data, which are active in the main memory. The retransmission and the above so-called backlearning from the main memory may ensue in a transmission block.

In some embodiments, if the boot memory area is not removed right after the conclusion of the data block, the update of its machine-related data ensues on a basis of chance, which may be oriented according to the respective update in the main memory of the machine control. It may then carried out “case by case”, which may relieve the data transfer via the interface to the boot memory.

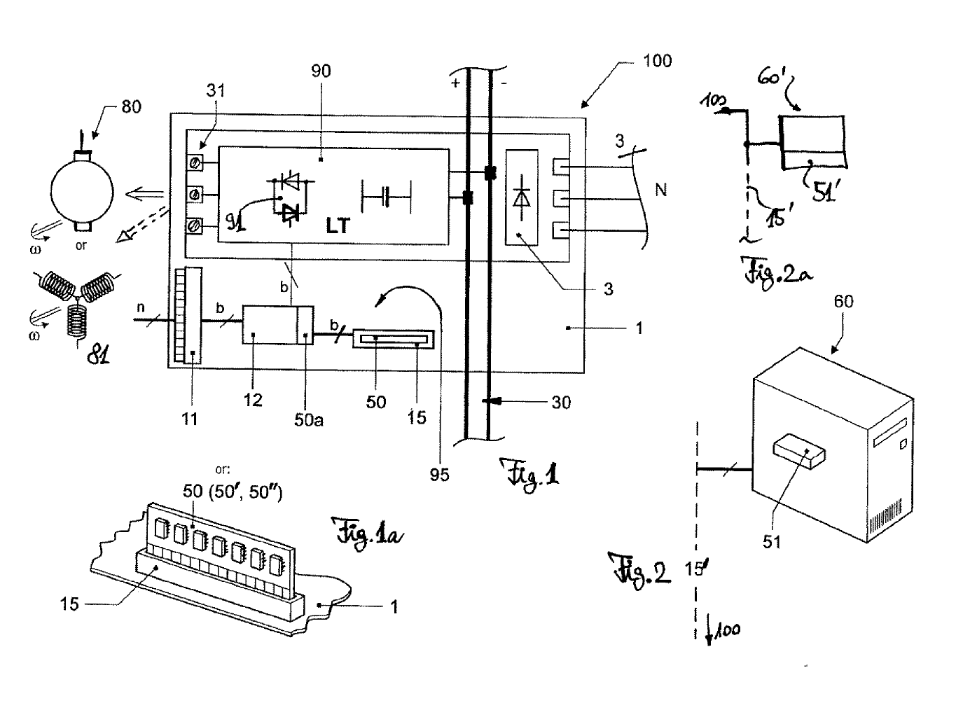

FIG. 1 is a schematic top view onto a machine control 100, which may be embodied on a circuit board 1. The circuit board 1 accommodates a power element LT or 90, which may be made up of power switches 91, which, from a direct current bus system 30, generate a controllable alternating current, which may be transmitted via the output terminals 31 to a three-phase machine 81. If a direct current machine 80 is used, provision is made for two output terminals 31 instead of three output terminals 31.

The function and operating method of a power element 90 for controlling a direct current machine or for controlling a two or multi-phase alternating current machine are generally known among experts so that the detailed explanations of the mode of operation of the power element 90 are not provided herein, but reference is instead made to the literature.

Input N forms a multi-phase system, which may be rectified in equal measure via the rectifier 3 for one or a number of machine controls 100 and which may be used for the formation of the bus system 30.

Particular attention is to be given herein to the activation of the power element 90 on the machine control. This functional section is labeled 95 and it consists of a control area 12 comprising at least one, but preferably a number of controllers, which may be in relationship with the machine, such as position control, current control or other user-specific controls. The relationship to the machine is to be seen in that it goes without saying that other variables, which relate to the machine, such as the current or the position or the acceleration, can be influenced by the controllers in the control area 12, prompted by target values and directed to manipulated variables in the power element 90. A memory area 50a, which forms a part of a larger memory, which represents the main memory, may be part of the control area 12. This memory area may be made up of rewritable memory cells of memory modules, which can be read quickly in a user-oriented manner.

In this control area, all of the systems are coupled to a bus, which has a bus width b and which, on the one hand, is branched to a measured value detection 11 and, on the other hand, to a base section 15, which accommodates a second memory area 50 so as to be capable of being inserted and removed, for example as a strip.

From the control area 12, control signals lead to the power element 90 either via the bus or via decided control lines for establishing the manipulated variables and/or the input signals of this power element and to correspondingly control the machine, as a motor and/or generator.

The base 15 accommodates a memory section 50, which may be designed as a module and may connect the electrical output terminals thereof with the bus of the data width “b”. Provision may also be made for a mechanical stability so that the memory module 50 may sit securely in the base 15, may be accommodated therein and can nonetheless be removed easily.

The parameters as such, which influence the control, are not illustrated, but they are components of the respective memory areas. Parameters are those, which are user-specific and those, which are not parameters explicitly, but which represent user programs that are handled like parameters, which may be disposed in the main memory 50a.

The memory area 50, which can be removed, is to be called a boot memory area. Data, which represent the named parameters, may be stored here. These are parameters, which influence the setting of the power element: threshold values, default values and other setting parameters. They are to be called “first parameters”. “Second parameters” are those, which are user-specific, also with reference to the type and design of the machine. This will be called second parameter group. This also includes user programs, which may be certain types of controllers and which comprise certain threshold value identifications or specific control processes, which are required for a “specific application” or for a specific machine.

In a normal operating mode, all of these programs and parameters may be stored in the main memory 50a.

If an application is to be started up for the first time, the machine control is, for the most part, free from specific defaults of the afore-mentioned type of first and second parameters, which must be first provided to the drive system by a start-up engineer via an interface, which is not illustrated herein. However, it is a specific design of the example described herein that such a start-up engineer must not perform any additional presettings via interfaces. In fact, these are performed via the module 50 (as memory module), which is disposed in the base 15 and which is transmitted into the main memory 50a via the bus b and a routine in the control area 12 (of on the memory module 50) as an entire segment of first and second parameters. This transmission from the boot memory area 50 of the module to the base 15 ensues initially, after the machine control 100 is turned on for the first time with the corresponding machine 80 or 81. The boot memory area 50 thereby transmits all of the machine-related data, which are provided thereon, which comprises at least said first and second parameters as groups. In the context of the second group, provision is also made for at least one user program, which may also be transmitted and stored in the main memory 50a so as to be capable of being executed.

The transmission of this sum of machine-related data from the module ends when all of the parameters (first and second group), which are required for an operation of the machine and of the machine control, have been transmitted.

The machine control 100 is then self-sustaining and can operate independently with the help of the control section 12 and the machine-related data in the main memory 50a, which may be transmitted in response to the start-up. Accessing or reverting to the boot memory area for this mode of operation does not take place. However, a re-update may be carried out, which result from self-regulating systems in the control area 12, for example. The self-regulating or adaptive systems may change certain parameters, which are user-specific, and may store the correspondingly changed parameters at the location of the output parameters in the appropriate memory cells. In a routine of the sequential program, which is not illustrated herein but which can be easily conceived, provision is made for updated parameters in the first or second group of parameters to be written back into the boot memory area 50 bit by bit, depending on the state of the update. There, they replace the output values.

In the course of the operation of the drive system 100, 80, the physical boot memory 50 is thus updated, it is learned back and the boot memory information does not remain unchanged.

If the control system is turned off with machine 100, 80, all of the information is available in the unitized memory area 50 via the achieved system state. In response to being turned on again, which corresponds to a second start-up, all of this machine-related data may be inquired again and may be taken over into the corresponding mirror boot memory area 50a, which forms the main memory.

The system thus achieves a backup copy in the removable memory 50. Said backup copy may not be not static, but may dynamically adapt itself to the respective new-found and adapted operating states.

If the memory area is removed as a module, it can be taken over at a different location into a comparable system, which is not illustrated, but which corresponds to FIG. 1. A series start-up is possible in a simplified manner. A system is started up, starting with one set of first and second parameters in the boot memory area 50. A period of time of the operation follows, in which an update of the machine-related data takes place in the boot memory area, and said memory can then be removed and used for the start-up of the next system.

It is apparent that the term start-up is understood in a more general manner herein. The term is to be understood to mean that a first-time start of an operation is included, just as a new start of an operation. However, it also includes the new turn-on procedure of the system, which had already been put into operation earlier.

In a non-illustrated exemplary embodiment, which can, however, be easily deduced from FIG. 1, the base 15 is provided as a data network coupling 15′. Said data network coupling leads away from the machine control 100, towards a physically far remote data arrangement, which may be capable of storing data and of operating the bus in a bidirectional manner. This host, which is to be described as being “remote” gathers the data and permits a turn-off procedure of the machine control. After the machine control has been turned on, it may restore the data via the bus control in line with the access routine. There, they may be stored in the mirror boot memory area 50a and may then be updated bit by bit and tracked in the course of the operation via the data network coupling (according to the strip 15). It is apparent that the memory 50, which may be designed as a removable module, may be designed herein as a remote memory 51, which must not be removable and portable, but which works in a functionally comparable manner.

FIG. 2 thus schematically shows a host 60, which encompasses a remote memory area 51. The host may be connected with the machine control 100 via the data network coupling 15′, wherein said data network coupling can be placed on the connection plug board 15 via a corresponding plug contact so that the host 60 with its boot memory area 51 can assume the same function as the portable memory 50, only without the characteristic of being portable itself. The schematic system of FIG. 2a also works accordingly. 60′ corresponds to 60; 51′ corresponds to 51 according to the preceding description.

The restoring or learning back of the parameters, which may be newly formed during operation, into the remote memory area 51 also takes place in the second and third exemplary embodiment, just not directly on the circuit board 1 of the motor control, but via the data connection 15′ to the remote memory area 51. The remote memory may provide for transmission in both directions, wherein these directions are to he understood to be the transmission of the entire machine-related data from the remote memory area 51 into the mirror boot memory area 50a on the one hand and, in the other direction, to be the update of the boot memory area 51 in the remote host 60, which may be formed bit by bit.

As stated above, the control area 12 may have number of controllers, which can be designed in a specific manner, as certain types of controllers or which can be provided as yet open types of controllers in an unspecific manner. They obtain their specific design only after the transmission of the group of the second parameters from the remote memory 51 or the module memory 50 into the main memory 50a. Yet unspecific controllers thus become specific controllers, which may be specific to the user situation.

After their transmission and after being stored in the main memory 50a, all of the transmitted machine-related data from the first and the second group of parameters may define the characteristic of the machine control 100.

The update of the boot memory areas 50 or 51 takes place in response to the data synchronization of the feedback of the newly learned parameters, for example without therein overwriting the programs, which may be user-specific and which may be taken over into the main memory 50a as user program in an unchanged form in response to every new start or in response to every new start-up. The data synchronization to the boot memory is thus not as extensive as the data transmission from the boot memory area 50 or 51 into the main memory 50a.

In the alternative, a program segment can also be overwritten. In response to the learning back, the overwriting may take place in the boot memory 50, in response to the start-up in the mirror boot memory.

The mode of operation of the start of the transmission from the boot memory area 50 or 51 into the main memory 50a is not illustrated. It can be prompted by means of turning on the machine control. This can also be prompted by a test program, which tests the first parameters, which are present in the main memory 50a, regarding valid parameters or which tests the programs, which are present there as second parameters, regarding their efficiency. If the test does not render a positive result, the transmission from the boot memory area 50 or 51, depending on the design, may be initiated, performed and concluded, before the complete executive control is again rendered to the machine control 100 as master. This executive control as master may be continued until the machine control 100 is turned off. A new routine, which completely transmits the memory area 50a in the main memory to the boot memory according to FIG. 1a or according to FIG. 2, may begin prior to the release. The turn-off procedure of the machine control 100 can be unlocked only after this transmission process has ended.

It is thus ensured that, in response to a new turn-on procedure or in response to a removal of the portable boot memory 50 for another start-up case, the current machine-related data may always be present in the boot memory, from where it may be taken over into the main memory 50a by means of the afore-described first routine in response to a turn-on procedure or in response to a start-up.

Modifications of the described methods of operation may be advantageous in line with the below possibilities.

In some embodiments, a first start-up may take place without a specific design to a respective application also by providing default settings from the boot memory area 50 or 51. These settings are not so minimalistic that a regular operation of the motor control 100 is not possible, but they also do not include the complete set of first and second parameters, as it has been realized in the afore-described examples. A reduced default setting, which seems to be suitable for a number of applications, would, in the course of the start-up, be transmitted from the boot memory into the main memory 50a and would thereafter transfer the control to the machine control, which improves the default setting in the course of the operation by means of appropriate adaptation methods and identification possibilities and tailors it to the application. The restoration may then improve the default storage in the boot memory areas 50 or 51.

In some embodiments, it may be preferable that the default setting identifies at least the type of the machine 80 or 81, thus to be specific and targeted to the type.

In some embodiments, the subdivision of the boot memory 50 as module into two independent modules, which can be removed independently, may also represent an advantageous design. The first and the second group of parameters may be read out of one of these modules and are written into the main memory 50a. In response to the data synchronization in terms of a learning back, the writing may take place on both independent modules at the same time. One of these modules may be replicated therewith and can be removed as an independent module and can be used for another start-up as a master. There, a replication can again take place, as with the first start-up system, into which a new independent memory may be inserted after the second memory has been removed for the next start-up.

The information obtained from the first start-up is thus stored on a number of removable independent boot memories, which can then be duplicated for the series start-up and a number of drives can be used in a simple manner and without highly-qualified start-up engineers.

In some embodiments, another use of the two or more independent boot memories 50 (then as independent memory elements 50′ and 50″) is possible. One of them can be stored as a permanent backup in an electrical cabinet at a safe location, so that it may be available as an emergency backup in case of a breakdown or failure. It goes without saying that this emergency backup 50″, which is stored outside of the slot 15 does not participate in the update, which the main boot memory 50, then as 50′, experiences. For such an equalization, a separate routine can be switched in an executable manner in the control area 12. This routine is triggered when the memory 50″, which has not been updated, is inserted into the base 15 next to the main boot memory 50′. The base 15 may thereby be extended or the memories may be shortened in each case.

In some embodiments, parallel USB ports, a number of which can be provided, are other possibilities. Updates of more than only two memories can then also be performed. The interface 15 as “base” is thus to be generally understood to be a data connection from the removable memory 50 or 50′ or 50″ or further memories, said data connection being able to also provide a physical holding function in addition to the electrical coupling.

The triggering of an updating routine in the control section 12 takes place in response to the identification of a newly inserted boot memory, which may be inserted into one of the available base locations 15, either alone or in addition to a master boot memory 50. The memory size must not be extensive; it can be designed to be less than 10 Mbyte or less than 5 Mbyte. Even if portable memory sticks are used, which have higher memory volumes, the handling can be crucial for the use of a larger memory, which itself however, may not be used completely.

In some embodiments, the restoration in response to an insertion of the boot memory into the base as “receptacle” 15 can take place in two ways. Either a full synchronization takes place by transmitting all of the first and second parameters from the main memory 50a of the control area 12, or a comparison takes place, which indicates which data of the entire machine-related data are to be updated in the inserted memory and said data are then updated. The latter transfer is the transfer, which requires less time, the first transfer can be carried out in a simplified manner.

The afore-described specifications can be used for different operations. A device exchange, an intelligent drive, a start-up and a series start-up, as well as a backup safeguard of the machine-related data, which has been acquired for the application.

For the series start-up it can also be considered that a bus address may be assigned to the removable boot memory area 50. The bus address can be set on the circuit board of the memory area via decode switches and can be changed as well. Provision may also be made on the circuit board for a preservation battery or the type of the memory type may be appropriately chosen for a long-term and permanent preservation of the stored data.

An insertion of the memory into the base 15 (also to be understood as bus slot) may trigger the data synchronization or at least initially the data comparison with the data, which may be available in the main memory 50a. If the boot memory 50 had already been inserted before the machine control 100 is turned on, the transmission of the machine-related data proceeds in reversed order. Subsequently, the removable boot memory area 50 can be used for other start-ups.

In some embodiments, instead of an adjustment with a decode switch, the bus address can also be a component of the first group of parameters. Analogously, this corresponds to an indirect addressing.

In some embodiments, each additional boot memory module, which may be inserted into the slot 15 without complete or with incomplete data, may receive the updated data from the main memory 50a of a machine of a drive control system comprising machine and machine control, which was already put into operation and which is in operation. The multiplication of the available machine-related data for further start-ups is thus possible.

In some embodiments, an exchange of at least one component or of a device in the field of machine control, but in particular of the entire main circuit board 100 of the machine control, does not lead to a loss of parameters, which have already been received, and of new parameters, which have been learned during operation. They may be located on the boot memory 50 and may have been written into this memory area bit by bit in the course of their creation. A sudden malfunction of the machine control 100 is also no longer a reason for the available data to be lost. In fact, they are secured in the mechanically removable boot memory 50, not only updated to a large extent but they are also updated as much as possible. Its removal from the machine control 100, which is to be exchanged, and the insertion into a non-illustrated slot 15* of a newly installed machine control 100* (not illustrated) immediately make this a complete use of the present machine control 100, without an extensive start-up relating to staff and time.

This also applies to failure rates caused by defects in the power element or control element of the machine control 100.

The embodiments of the present inventions are not intended to be limited in scope by the specific embodiments describe herein. Thus, modifications are intended to fall within the scope of the following appended claims. Further, although some of the embodiments of the present inventions have been described herein in the context of a particular implementation in a particular environment for a particular purpose, those of ordinary skill in the art should recognize that its usefulness is not limited thereto and the embodiments of the present inventions can be beneficially implemented in any number of environments for any number of purposes. Accordingly, the claims set forth below should be construed in view of the full breadth and spirit of the embodiments of the present inventions as disclosed therein. While the foregoing description includes many details and specificities, it is to be understood that these have been included for purposes of explanation only, and are not to be interpreted as limitations of the inventions. Modifications to the embodiments described above can be made without departing from the spirit and scope of the disclosure.

1. A method for starting-up an electrical machine drive control system for a first start-up or for a new start-up performed after a device or component exchange, the machine drive control system including at least one machine and at least one machine control, the method comprising:
providing a boot memory area for storing machine-related data, the boot memory area including at least first parameters for a number of controllers and user-specific second parameters of the drive control system;
storing the first and second parameters in the boot memory area;
organizing the boot memory area on a module; and
transmitting all machine-related data from the boot memory area to the machine control,
wherein the module is capable of being removably inserted into the machine control.

2. The method according to claim 1, wherein the first and second parameters comprise the parameters for an operation of the machine and the machine control.

3. The method according to claim 2, wherein the second user-specific parameters also include user-specific programs, wherein the user-specific programs are specific to a respective application of a drive control system as user programs.

4. The method according to claim 1 further comprising:
reading the first and user-specific second parameters out of the boot memory area in response to the machine control start-up; and
transmitting and storing them in a mirror boot memory area provided in a main memory of the machine control,
wherein all of the machine-related data located in the mirror boot memory area are overwritten.

5. The method according to claim 4, wherein, with the transmission of the machine-related data, user programs in the mirror boot memory area are at least partially overwritten as well with user program data from the boot memory area as part of the user-specific second parameters.

6. The method according to claim 5, wherein user program data stored in a main memory of the machine control is changed from the outside for the purpose of changing the behavior pattern of the user program.

7. The method according to claim 6, wherein a change from the outside ensues under the influence of a PC tool.

8. The method according to claim 6, wherein from the mirror boot memory a transmission of at least parts of user programs to the boot memory area ensues and the corresponding parts of the stored user programs are overwritten.

9. The method according to claim 8, further comprising:
transmitting and overwriting a respective entire user program.

9a. (canceled)

9b. (canceled)

9c. (canceled)

10. A method for starting up an electrical machine drive system, the electrical machine drive system including at least one machine and a machine control, the machine control including a number of specific controllers which are assigned to the machine, the method comprising:
providing a boot memory area for readably storing machine-related data, wherein the machine-related data includes at least a number of first parameters of the number of specific controllers and a number of user-specific second parameters of the drive system;
storing the first and second parameters in the boot memory, wherein the boot memory is physically remote from the machine control; and
coupling the boot memory area with the machine control via a data network connection for transmitting the machine-related data in both directions.

11. The method according to claim 10, wherein the first and second parameters stored in the boot memory areas prior to a first start-up are default settings, wherein the default settings are at least not completely specific to a respective application.

12. The method according to claim 11, wherein, prior to a first start-up, the first and second parameters are specific and in line only with regard to a type of the machine.

13. The method according to claim 1, wherein the boot memory area is divided into two boot memory areas, wherein the two boot memory areas are independent and can be removed separately.

14. The method according to claim 13 wherein the memory size of the boot memory area is less than 10 MB.

15. The method according to claim 1, wherein an insertion of the module, which comprises the boot memory area, into the machine control in an operating machine drive control system, triggers a transmission of motor-specific data from a mirror boot memory area on the machine control into the boot memory area.

16. The method according to claim 1, further comprising:
comparing one motor-specific data in a mirror boot memory area of a main memory with another motor-specific data in the boot memory area, wherein the comparison is triggered by an insertion of the boot memory area into the machine control in an operating machine drive control system.

17. The method according to claim 16, wherein a data matching of only the different motor-specific data in the two memory areas ensues by means of a transmission of the one motor-specific data from the mirror boot memory area of the machine control into the boot memory area.

18. The method according to claim 10, wherein user programs are a component of the second parameters.

19. The method according to claim 10, wherein a modification storage follows a transmission of machine-related data, for changing at least a part of a stored user program.

20. The method according to claim 10, wherein the boot memory area is secured against a power failure.

21. The method according to claim 10, wherein a data matching of at least some of the machine-related data ensues in a normal operation of the drive control system by transmitting updated first second parameters from the machine control into the boot memory area, whereby the previous first and second parameters are overwritten in the boot memory area.

22. The method according to claim 21 wherein user programs are not overwritten in the boot memory area during the data matching.

23. The method according to claim 10, wherein the machine control is designed and equipped prior to its start-up to:
read the first and second parameters out of the boot memory area in response to its start-up; and
store the read first and second parameters in a provided particular mirror boot memory area in a main memory of the machine control and to overwrite all of the machine-related data located therein, respectively.

24. The method according to claim 23, wherein, after a completion of a transmission from the boot memory area into the mirror boot memory area, a control of the machine ensues, via a control section of the machine control with the first and second parameters, with the user-specific programs in the mirror boot memory area.

25. The method according to claim 23, wherein a direct control of the machine out of the boot memory area does not ensue.

26. The method according to claim 23, wherein an identification of valid parameters or valid user programs in the mirror boot memory area prompts a transmission from the boot memory area into the mirror boot memory area.

27. The method according to claim 23, wherein a turn-on process of the machine drive control system triggers the transmission from the boot memory area.

28. The method according to claim 23, wherein a turn-off process of the machine drive control system triggers a transmission of the mirror boot memory area into the boot memory area.

29. The method according to claim 1, wherein a strip is arranged as a base on the machine control for inserting and removing the boot memory area, the strip comprising a mechanical holder and an electrical interface.

30. The method according to claim 1, further comprising:
providing a slot for inserting or removing the boot memory area.

31. The method according to claim 1, wherein the machine-related data is transmitted from the boot memory area to the machine control in response to an inserted boot memory area and a subsequent turn-on process of the machine control.
